(19) United States
(12) Patent Application Publication
(10) Pub. No.: US 2013/0138673 A1
(43) Pub. Date: May 30, 2013

(54) INFORMATION PROCESSING DEVICE, INFORMATION PROCESSING METHOD, AND PROGRAM

(71) Applicants: Tomonori Uemura, Kyoto (JP); Ryota Tsukidate, Osaka (JP)

(72) Inventors: Tomonori Uemura, Kyoto (JP); Ryota Tsukidate, Osaka (JP)

(73) Assignee: PANASONIC CORPORATION, Osaka (JP)

(21) Appl. No.: 13/612,344

(22) Filed: Sep. 12, 2012

Related U.S. Application Data
(63) Continuation of application No. PCT/JP2012/002146, filed on Mar. 28, 2012.

(30) Foreign Application Priority Data
Nov. 29, 2011 (JP) 2011-259961

(51) Int. Cl. G06F 17/30

(52) U.S. Cl. 707/758; 707/E17.014

(57) ABSTRACT

Provided is an information processing device for extracting a comment having additional information and posted to a program, the information processing device comprising: a program information acquisition unit; a search word determination unit which determines a search word which is a candidate for a term indicating relation between the search word and the program; a comment acquisition unit which searches through comments each having the additional information and already posted, using the search word to acquire a search result as a comment group; a search word relation determination unit which determines whether there is a relation between the search word and the program, using the broadcast time and a time at which each comment included in the comment group is posted; and an input/output unit which outputs information indicating the search result if there is the relation between the search word and the program.

### CROSS REFERENCE TO RELATED APPLICATION

This is a continuation application of PCT Patent Application No. PCT/JP2012/002146 filed on Mar. 28, 2012, designating the United States of America, which is based on and claims priority of Japanese Patent Application No. 2011-259961 filed on Nov. 29, 2011. The entire disclosures of the above-identified applications, including the specifications, drawings and claims are incorporated herein by reference in their entirety.

### FIELD

The present disclosure relates to information processing devices, information processing methods, and programs. The present disclosure particularly relates to an information processing device, an information processing method, and a program which output information on a comment posted in relation to a broadcast program.

### BACKGROUND

Video viewing services are widely used over the Internet. For example, there is a service called NICONICO DOUGA (registered trademark). Such a service allows users to freely add comments on posted videos. Moreover, when viewing a video, comments added by other users are displayed overlaying the video and thus the users can enjoy other users' comments as well as the video.

There is an increasing number of viewing methods to provide a viewer with enjoyment of broadcast programs while the viewer reading comments in social networking service (SNS) (hereinafter, referred to as “SNS comment”) related to a program at the same time viewing the program. Examples of services providing viewers such a viewing method include twtv.jp (registered trademark) which collectively displays comments (Tweet) which are related to a specific program and posted at Twitter (registered trademark) which is an SNS comment distribution service, and TVRoll (registered trademark) which collectively displays not only Tweet at Twitter (registered trademark) but also the posts on BBS.

In Torne (registered trademark) that provides functionality allowing users to view terrestrial digital broadcasting using PlayStation3 (registered trademark), there is Torne Live which provides functionality allowing, on a screen on which a broadcast program is viewed, Tweet related to the program to be displayed.

As described above, it is becoming common for users to enjoy a video while reading related SNS comments, as a video viewing method. To achieve such a viewing method, how to acquire the SNS comments related to the viewing video is important.

Conventionally, technique is disclosed in which a summary graph representing frequency, over time, of posting content-related information that includes a specific character string is created and a viewer selects (and play) a position on the graph (for example, PTL 1).

Moreover, technique is disclosed in which the level of attention is estimated based on the number of hits for a search keyword, or temporal changes in number of users, and keywords having high levels of attention are preferentially displayed (for example, PTL 2).

### CITATION LIST

### Patent Literature

[PTL 1] Japanese Unexamined Patent Application Publication No. 2005-223534
[PTL 2] Japanese Unexamined Patent Application Publication No. 2005-309998

### SUMMARY

### Technical Problem

A search method based on a character string (hashtag) described in the SNS comment to indicate a relation to a specific program is known as efficient to acquire SNS comments related to the program. Examples of a method to obtain the hashtag (hashtag unique to program) related to the program are as follows.

(1) Acquire an official hashtag released by a program provider, from the program provider.

(2) Acquire a hashtag proposed by a user community as being related to the program, from database of the user community.

(3) Deduce a hashtag in relation to a program, based on program information such as a title of the program.

Among the hashtags acquired by the methods (1) to (3) described above, however, which hashtag is actually used by a user as a program unique hashtag is not uniquely determined. This is because the user changes the hashtag, based on experience from actual use of the hashtag, and, as a result, an accessible hashtag is used. In addition, the user is allowed to create any new hashtag and add comment to the hashtag, and thus the lifecycle of the program unique hashtag from its appearance to the disappearance is, in most cases, short. Therefore, there is no method of identifying a program unique hashtag that is actually used among users. As a result, there arises a problem that comment posted to a program cannot be extracted correctly.

Thus, it is necessary to obtain information for correctly extracting a comment posted to a program.

One non-limiting and exemplary embodiment provides an information processing device or the like which obtains information for correctly extracting a comment posted to a program.

### Solution to Problem

In one general aspect, the techniques disclosed here feature an information processing device for outputting information on a comment having additional information and posted in relation to a program to an external server, the information processing device including: a program information acquisition unit configured to acquire program information which includes information indicating a broadcast time during which the program is broadcasted; a search word determination unit configured to determine a first search word which is a candidate for a term described in the additional information to indicate a relation to the program; a comment acquisition unit configured to search through comments each having the additional information and already posted, using, as a search key, the first search word determined by the search word determination unit, to acquire a search result as a first comment group; a search word relation determination unit configured to determine whether there is a relation between the first search word and the program, using the broadcast time and a time at which each of the comments included in the first comment group acquired by the comment acquisition unit is posted; and an output unit configured to output information indicating the search result when the search word relation determination unit determines that there is the relation between the first search word and the program.

According to the above configuration, the information processing device, when the program information is given, can estimate the search word (the first search word) related to the program, based on the program information and the comments already posted, and output the comment obtained by searching using the estimated search word or information indicating the comments. Thus, the information processing device can obtain information for correctly extracting the comments that are posted to the program.

Preferably, for the number of comment posts per unit time of the comments included in the first comment group, when the number of posts during the broadcast time of the program is greater than the number of posts off the broadcast time of the program, the search word relation determination unit is configured to determine that there is the relation between the first search word and the program.

According to the above configuration, it is determined whether the search word (the first search word) related to the program is the search word that is actually used by the user. This is because a large number of comments in which the search word related to the program is described are posted during the broadcast time of the program.

Preferably, for the number of comment posts per unit time of the comments included in the first comment group, when the number of posts increases before a start time of the program, the number of posts during the broadcast time of the program is greater than or equal to a predetermine value, and the number of posts decreases after an end time of the program, the search word relation determination unit is configured to determine that there is the relation between the first search word and the program.

According to the above configuration, it is determined whether the search word (the first search word) related to the program is the search word that is actually used by the user. This is because the users start posting comments to the program before the start time of the program, continue posting comments during the broadcast time of the program, and end positing comments after the end of the program.

Preferably, when the number of comment posts per unit time of the comments included in the first comment group increases before a start time of the program and is greater than or equal to a predetermined value during the broadcast time of the program, the search word relation determination unit is configured to determine that there is the relation between the first search word and the program.

According to the above configuration, it is determined, during the program broadcast time, whether the search word (the first search word) related to the program is the search word that is actually used by the user. This is because the users start posting comments to the program before the start time of the program, and continue posting comments during the broadcast time of the program.

Preferably, when patterns of change in the number of comment posts per unit time of the comments included in the first comment group corresponding to two of a plurality of the first search words are similar to each other, the search word relation determination unit is configured to determine that there is the relation between the program and each of the two of the plurality of first search words.

Preferably, when a sum of differences between the number of comment posts per unit time of the comments included in the first comment group corresponding to one of two of a plurality of the first search words and a constant multiple of the number of comment posts per unit time of the comments included in the first comment group corresponding to the other of the two of the plurality of first search words in a predetermined time period is smaller than a predetermined value, the search word relation determination unit is configured to determine that there is the relation between the program and each of the two of the plurality of first search words.

According to the above configuration, it is determined whether the search word (the first search word) related to the program is the search word that is actually used by the user. This is because if there is a plurality of search words for the same program, the search words have the same change pattern before the broadcast time of the program, during the broadcast time, and after the broadcast time. More specifically, when there are two search words A and B for the same program and the number of users using the search word A is C times the number of users using the search word B, the number of comments that include the search word A is C times the number of comments that include the search word B.

Preferably, the search word determination unit is configured to determine as the first search word a character string extracted from a description in each of the comments having the additional information and already posted.

According to the above configuration, the search word (the first search word) related to the program can be extracted from the comments actually posted by users, and thus the search word is highly likely to be in relation to the program. Therefore, the information processing device can effectively extract the comments posted to the program.

Also, preferably, the information processing device further including a search word extraction unit configured to extract a second search word different from the first search word from a description in each of the comments included in the first comment group, wherein the comment acquisition unit is configured to search through the comments each having the additional information and already posted, using the second search word as the search key, and acquire a search result as a second comment group, the search word relation determination unit is configured to determine whether there is an relation between the second search word and the program, using the broadcast time and a time at which each of the comments included in the second comment group is posted, and when the search word relation determination unit determines that there is the relation between the second search word and the program, the output unit is configured to output information indicating the search result obtained by searching through the comments using the second search word as the search key.

According to the above configuration, among the comments obtained by searching using the first search word, the second search word appropriate for identifying the program can be estimated and comments obtained by searching using the estimated search word, or the information indicating the comment can be outputted. Thus, the information processing device can accurately and correctly extract the comments posted to the program.

Preferably, using the second search word as a new first search word, the information processing device recursively and iteratively performs a series of processing steps including acquiring the first comment group by the comment acquisition unit, determining a relation between the new first search word and the program by the search word relation determination unit, and outputting a search result by the output unit, and when a predetermined condition is met, the information processing device ends the series of processing steps.

Preferably, when the series of processing is performed for a predetermined number of times, the information processing device ends the series of processing.

Preferably, the information processing device ends the series of processing steps when a total number of pieces of information indicating the search result obtained by searching through the comments using the second search word outputted in each of the series of processing steps is greater than a predetermined value.

Preferably, the information processing device ends the series of processing steps when a total number of comments included in the first comment group and the second comment group in the series of processing steps is greater than a predetermined value.

Preferably, the information processing device ends the series of processing steps when a total number of comments included in the second comment group in the series of processing steps is smaller than a predetermined value.

Preferably, the information processing device ends the series of processing steps when a ratio of the number of comments which include the second search word extracted from each of the comments included in the first comment group to the number of comments included in the first comment group in the series of processing steps is smaller than a predetermined value.

According to the above configurations, the information processing device estimates a new search word described in the comments obtained by searching using the estimated search word. Thus, the information processing device can accurately and correctly extract the comments posted to the program.

Also, preferably, the program information includes information indicating the broadcast time during which the program is broadcasted and information indicating a broadcasting station which broadcasts the program.

According to the above configuration, a broadcasting station broadcasting the program, to which the comments to be acquired by the comment acquisition unit and to be included in the first comment group are posted, can be narrowed down based on the broadcasting station of the program, thereby narrowing comments to be included in the first comment group down to those related to the broadcasting station of the program comments for which is searched for. Thus, the information processing device can accurately and correctly extract the comments posted to the program.

Preferably, the information processing device further including an input unit configured to receive, as input, information whereby the program for which broadcasting has already been finished is identified, wherein the output unit is configured to output information indicating the search result obtained by searching through the comments using at least one of the first search word and the second search word determined, by the search word relation determination unit, to be related to the program.

According to the above configuration, the information processing device can estimate, in advance, the search word related to the program previously broadcasted, store information indicating the result of searching using the search word, and output information indicating the result of searching using the search word, as a response to an inquiry from the user.

Preferably, the information processing device further including an input unit configured to receive, as input, information whereby the program being broadcasted is identified, wherein the output unit is configured to output information indicating the search result obtained by searching through the comments using at least one of the first search word and the second search word determined, by the search word relation determination unit, to be related to the program.

According to the above configuration, the information processing device can output, during the broadcast time of the program, the information indicating the result of searching using the search word, as a response to an inquiry from the user.

The information processing device according to one aspect of the present disclosure is an information processing method for outputting information on a comment having additional information and posted in relation to a program to an external server, the information processing method including: acquiring program information which includes information indicating a broadcast time during which the program is broadcasted; determining a first search word which is a candidate for a term described in the additional information to indicate a relation to the program; searching through comments each having the additional information and already posted, using, as a search key, the first search word determined in the first search word determination to acquire a search result as a first comment group;

determining whether there is a relation between the first search word and the program, using the broadcast time and a time at which each of the comments included in the first comment group acquired in the first comment group acquisition is posted; and

outputting information indicating the search result when it is determined that there is the relation between the first search word and the program in the relation determination.

According to the above configuration, the same advantageous effects as those of the information processing device are achieved.

It should be noted that the present disclosure can be achieved not only as a device but also as a method including steps performed by processing units included in the device, a program for causing a computer to execute such steps, a computer-readable storage medium, such as CD-ROM, having recorded therein the program, or information, data or signals indicating the program. In addition, such program, information, data, and signals may be distributed via a communication network such as the Internet.

### Advantageous Effects

As described above, according to the information processing device of the present disclosure, information for correctly extracting a comment posted to a program can be obtained from program information and comments already posted to the program.

### BRIEF DESCRIPTION OF DRAWINGS

These and other objects, advantages and features of the present disclosure will become apparent from the following description thereof taken in conjunction with the accompanying drawings that illustrate specific embodiments of the present disclosure.

FIG. 1 is a functional block diagram of an information processing device 1 according to a non-limiting embodiment 1

FIG. 2 is a flowchart illustrating an example of operation of the information processing device 1 according to the embodiment 1.

FIG. 3 is a venn diagram showing an example of a set of hashtags for acquired comments.

FIG. 4 is a venn diagram showing another example of the set of hashtags for acquired comments.

FIG. 5 is a venn diagram showing another example of the set of hashtags for acquired comments.

FIG. 6 shows an example of time distribution chart of acquired comments.

FIG. 7 shows another example of the time distribution chart of acquired comments.

FIG. 8 shows another example of the time distribution chart of acquired comments.

FIG. 9 is a functional block diagram of an information processing device 2 according to a non-limiting embodiment 2

FIG. 10 is a flowchart illustrating an example of operation of the information processing device 2 according to the embodiment 2.

FIG. 11 is a flowchart illustrating another example of operation of the information processing device 2 according to the embodiment 2.

FIG. 12 is a diagram showing an example of a system which includes the information processing device according to the present disclosure.

FIG. 13 is a diagram showing an example of a display screen of a tablet terminal according to the present disclosure.

FIG. 14 is a diagram showing another example of the system which includes the information processing device according to the present disclosure.

FIG. 15 is a diagram showing another example of the system which includes the information processing device according to the present disclosure.

### DESCRIPTION OF EMBODIMENTS

It should be noted that the embodiments described below are each merely a preferred illustration of the present disclosure. Values, shapes, materials, components, disposition or a form of connection between the components, steps, and the order of the steps are merely illustrative, and are not intended to limit the present disclosure. Moreover, among components of the below non-limiting embodiments, components not set forth in the independent claims indicating the top level concept of the present disclosure will be described as optional components for preferable embodiments.

It should be noted that whenever possible, the same reference signs will be used to refer to the same components and the description may be omitted.

### Embodiment 1

In the present embodiment, an example of an information processing device will be described which estimates a search word related to a program, based on program information and already posted comments, when the program information is given, and outputs a comment obtained by searching using the estimated search word or information indicating the comment. It should be noted that the comment herein is a character string posted in relation to the program and includes information, review, or the like that is related to the program. Moreover, the comment may include a search word as additional information added to the comment. The comment and the additional information herein are collectively referred to as “the comment having the additional information.” The comment means “the comment having the additional information” unless otherwise stated herein.

(System Description)

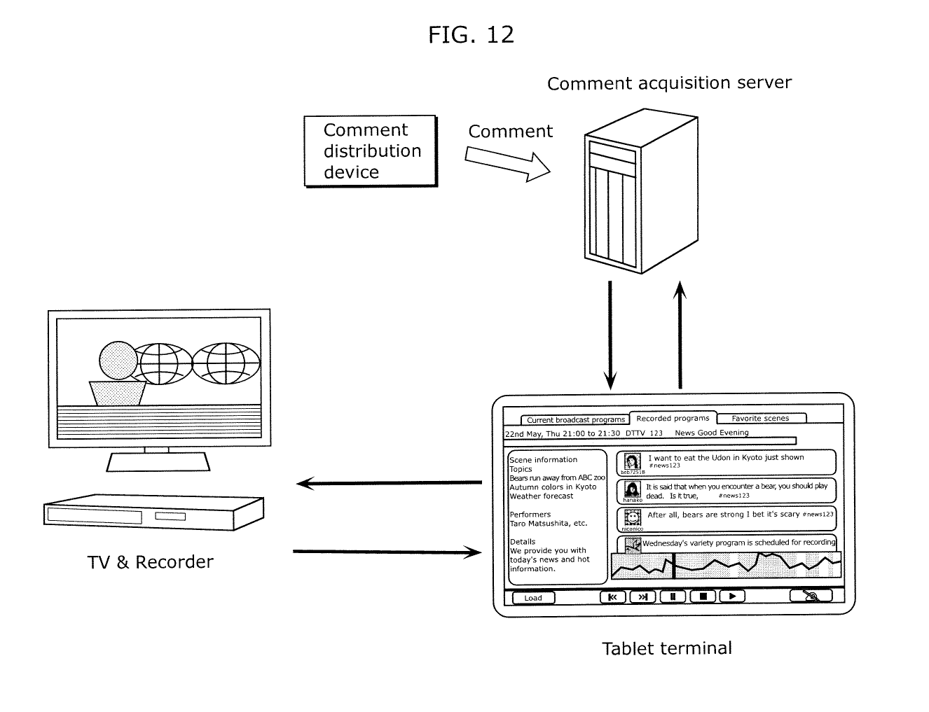

FIG. 12 is a diagram showing an example of a system which includes an information processing device 1 according to a non-limiting embodiment 1 of the present disclosure. In the system, a tablet terminal cooperates with a recorder and a comment acquisition server to display an SNS comment related to a program recorded in the recorder, in conjunction with playing back the recorded program. While the recorded program is being played back by the recorder, the tablet terminal acquires, from the recorder, information on the program being played back, and using the acquired program information, acquires the SNS comment related to the program from the comment acquisition server and displays the SNS comment.

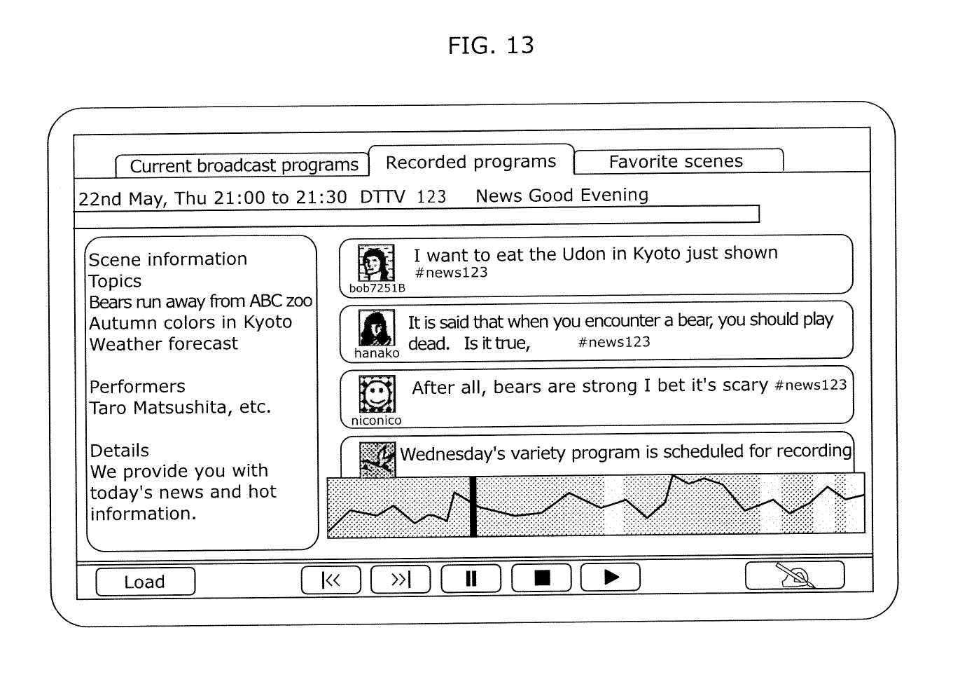

FIG. 13 is a diagram showing an example of a display screen of the tablet terminal according one embodiment of the present disclosure. On an upper portion of the screen of the tablet terminal, broadcast date and time, a broadcast channel, and a program title are displayed as information on the program being played back by the recorder. On a left side portion of the screen, scene information on the playing program is displayed. The scene is a portion of the program which is obtained by separating the program in correspondence with a batch of the content. The scene information is information on the scene and includes content of the scene, products featured in the program or the scene, or shop information. On a right middle portion of the screen, SNS comments related to the playing program are displayed. User convenience can be enhanced by automatically scrolling the SNS comments, in accordance with the course of the program. On a lower right portion of the screen, a graph is displayed where the number of SNS comments is indicated on the vertical axis and the elapsed time of the program is indicated on the horizontal axis. A user is allowed to check how many SNS comments are posted at which time during the broadcast time of the program.

In the following description of embodiments, the comment acquisition server is illustrated as the information processing device 1 according to the present disclosure. However, the information processing device 1 according to the present disclosure may not necessarily be a device independent as a server, and may be included as one function of the recorder or the tablet terminal.

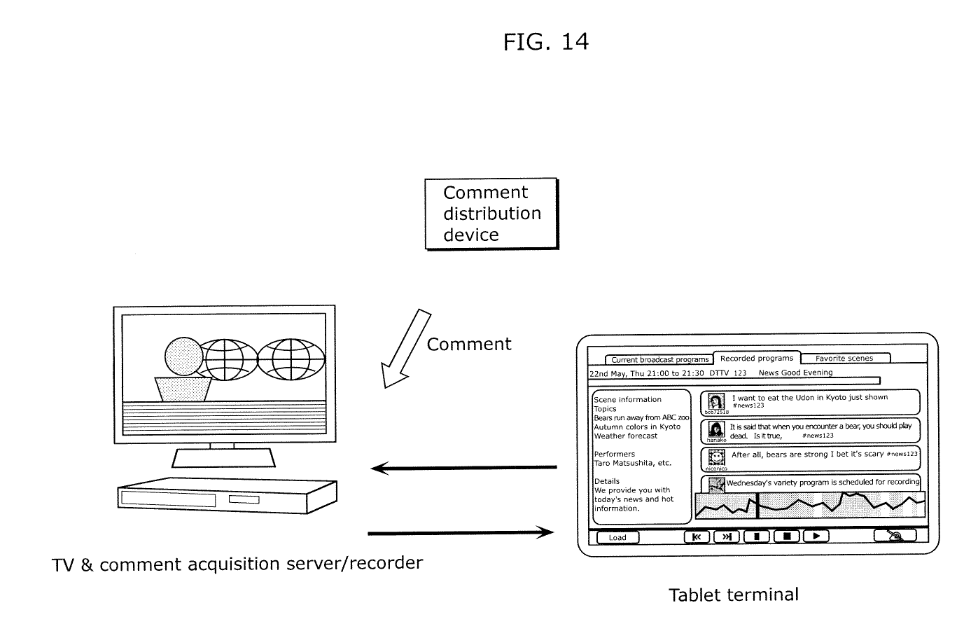

FIG. 14 is a diagram showing another example of the system which includes the information processing device 1 according to one embodiment of the present disclosure. The system shown in FIG. 14 depicts a recorder as the information processing device 1. In this case, the recorder also serves as the comment acquisition server, and thus the system includes the recorder and the tablet terminal.

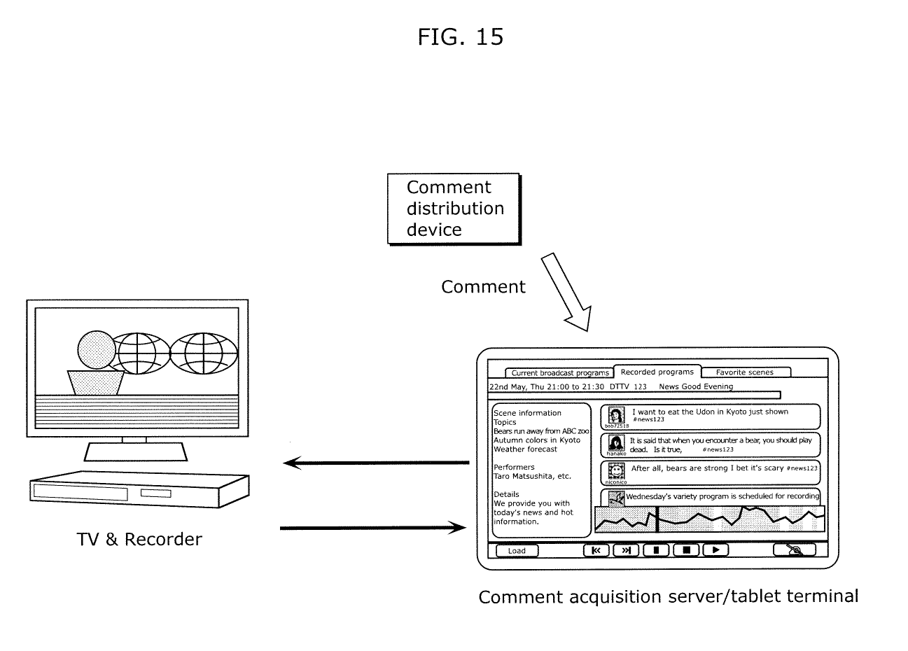

FIG. 15 is a diagram showing another example of the system which includes the information processing device 1 according to one embodiment of the present disclosure. The system shown in FIG. 15 depicts a tablet terminal as the information processing device 1. In this case, the tablet terminal also serves as the comment acquisition server. Similarly to the case of the recorder as the information processing device 1, the system includes the recorder and the tablet terminal.

(1. Configuration)

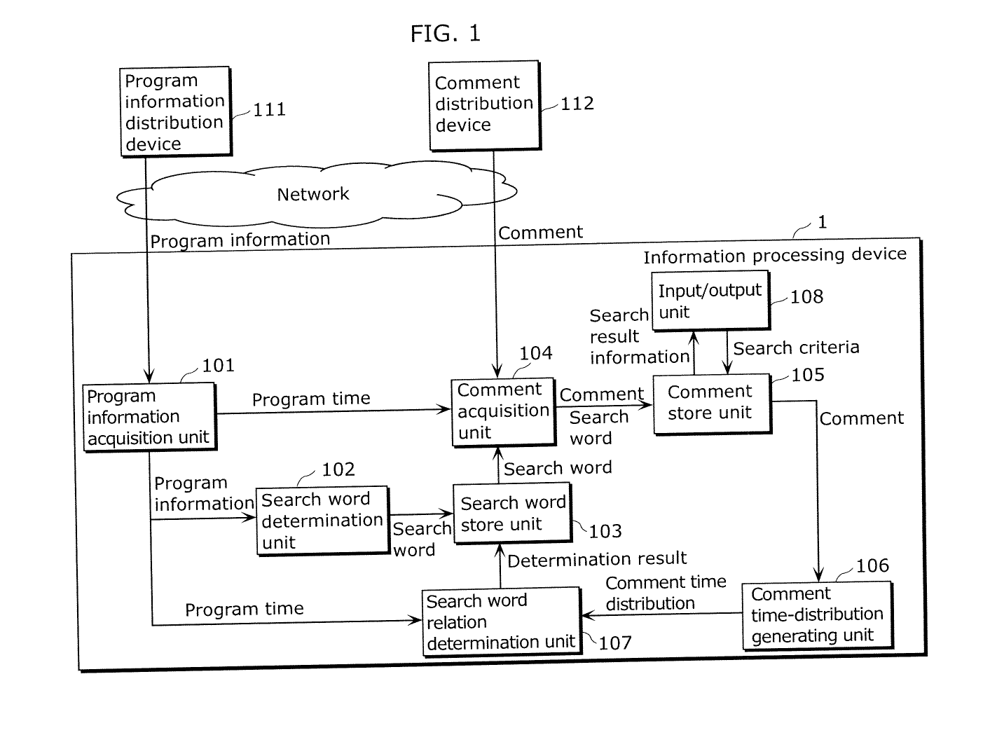

FIG. 1 is a functional block diagram of the information processing device 1 according to the present embodiment.

(Overall Configuration)

As shown in FIG. 1, the information processing device 1 according to the present embodiment includes a program information acquisition unit 101, a search word determination unit 102, a search word store unit 103, a comment acquisition unit 104, a comment store unit 105, a comment time-distribution generating unit 106, a search word relation determination unit 107, and an input/output unit 108.

(Program Information Acquisition Unit 101)

The program information acquisition unit 101 acquires program information which includes at least a broadcast time of a program. The program information acquisition unit 101 informs the acquired program information to the search word determination unit 102, the comment acquisition unit 104, and the search word relation determination unit 107. It should be noted that the broadcast time may be information whereby a time during which the program is broadcasted can be identified. Specifically, the broadcast time may be the start time and end time of the program. Alternatively, the broadcast time may be the start time and duration time of the program. The program information may include a name of a broadcasting station broadcasting the program, the program title, names of performers, or the like.

(Search Word Determination Unit 102)

The search word determination unit 102 determines a search word (a first search word) for use in acquiring a comment. The search word is information which is described in the comment to indicate an event to which the comment relates, and examples of which include an ID or a tag of the comment, or a keyword. For example, in the case of Twitter (registered trademark), a keyword called hashtag can freely be added to a comment (Tweet), and in acquiring a comment (Tweet) related to a predetermined event, the hashtag can be used as a search key. The search word determination unit 102 receives the program information from the program information acquisition unit 101, and passes the determined search word to the search word store unit 103.

(Search Word Store Unit 103)

The search word store unit 103 temporarily stores therein one or more search words for use in acquiring a comment. As a store method, database (DB) may be used, or other store method may be used. The search word store unit 103 receives the search word from the search word determination unit 102. Upon request from the comment acquisition unit 104, the search word store unit 103 passes a search word in response to the request, to the comment acquisition unit 104. Furthermore, upon reception of an instruction of deletion of a search word, from the search word relation determination unit 107, the search word store unit 103 deletes the specified search word.

(Comment Acquisition Unit 104)

The comment acquisition unit 104 uses the search word to acquire a comment. The comment acquisition unit 104 receives the program information and the search word from the program information acquisition unit 101 and the search word store unit 103, respectively, and passes to the comment store unit 105 a comment acquired based on the received program information and the received search word.

(Comment Store Unit 105)

The comment store unit 105 stores therein the acquired comment. As a store method, it is desirable to use DB. However, other store method may be used. Upon requests from the comment time-distribution generating unit 106 and the input/output unit 108, the comment store unit 105 passes the comment in response to the requests, to the comment time-distribution generating unit 106 and the input/output unit 108.

(Comment Time-Distribution Generating Unit 106)

The comment time-distribution generating unit 106 generates a time distribution of the acquired comments, based on a time at which each of the acquired comments is posted. An example of the method of generating the time distribution is to identify a time at which the acquired comment is posted and calculate the number of comments per minute. The comment time-distribution generating unit 106 receives comments from the comment store unit 105 and passes the calculated comment time distribution to the search word relation determination unit 107.

(Search Word Relation Determination Unit 107)

The search word relation determination unit 107 determines whether the search word used for the comment acquisition is unique to the program, based on the program broadcast time and the comment time distribution of the acquired comments. One example of the determination method is as follows. It is determined that the search word used for the comment acquisition is unique to the program if the comment time distribution indicates that the number of comments increases before the program start time, the number of comments more than a predetermined value are present during the broadcast time of the program, and the number of comments decreases after the program end time.

Another example of the determination method is as follows. It is determined that the search word used for the comment acquisition is unique to the program if the comment time distribution indicates that the number of comments increases before the program start time and the number of comments more than a predetermined value are present during the broadcast time of the program.

The search word relation determination unit 107 receives the program information and the comment time distribution from the program information acquisition unit 101 and the comment time-distribution generating unit 106, respectively. If it is determined, as a determination result, that the search word is not unique to the program, the search word relation determination unit 107 gives the search word store unit 103 a deletion instruction of the search word.

(Input/Output Unit 108)

The input/output unit 108 receives search criteria for the comment, as input information, and outputs a comment matching the search criteria. Examples of the search criteria include a start time and an end time. The input/output unit 108 passes the inputted search criteria to the comment store unit 105 and outputs the comment received from the comment store unit 105. The input/output unit 108 is by way of example of an output unit. The input/output unit 108 is also by way of example of an input unit.

(2. Operation)

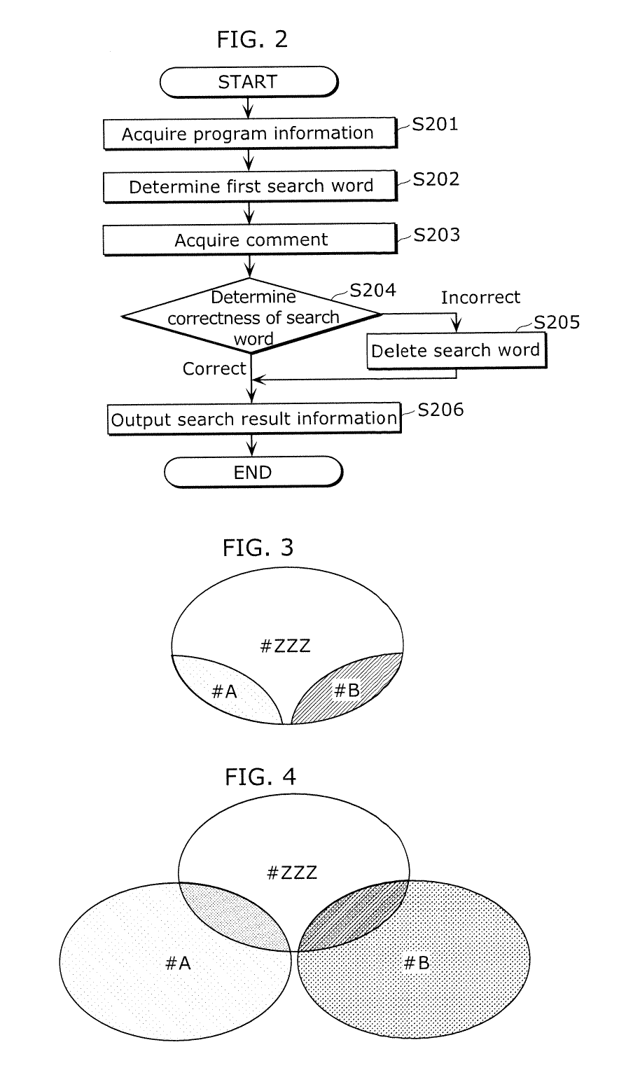

FIG. 2 is a flowchart illustrating an example of operation of the information processing device 1 according to the embodiment 1. In the below description, a case will be described where a comment (Tweet) of Twitter (registered trademark) is acquired, using Twitter (registered trademark) by way of example of the SNS comment distribution service. Herein, the comment may be written as Tweet and the search word may be written as hashtag.

(Program Information Acquisition S201)

The program information acquisition unit 101 acquires the program information on a program Tweet for which is to be acquired. Examples of a source from which the program information is acquired include the use of iEPG (Internet Electronic Program Guide) which is a television listings provision service on the Internet. Moreover, other servers or services which provide television program information may be used.

(Search Word Determination Process S202)

The search word determination unit 102 determines a hashtag whereby comments are acquired, based on the program information informed of by the program information acquisition unit 101. One method of determining a hashtag is to access a website where hashtags are managed on the Internet, and acquire a hashtag related to a program, based on a program title. Moreover, other methods include a method to deduce a hashtag related to a program, based on the program title, a method using a hashtag unique to a broadcasting station that broadcasts the program, and a method using a character string extracted from descriptions of already posted comments. Furthermore, a character string may be used which is extracted from descriptions of comments posted in a time slot which includes before and after the broadcast time of the program, among already posted comments. Employment of other method is possible insofar as the method results in determining the hashtag.

Furthermore, one of other methods of determining the hashtag is to select a hashtag from among hashtags included in previously acquired Tweet. This method will be described with reference to FIG. 3.

FIG. 3 is a venn diagram showing an example of a set of hashtags in acquired comments. There is a case, as shown in FIG. 3, where Tweet having a hashtag “#A” added thereto and Tweet having a hashtag “#B” added thereto, in addition to Tweet having a hashtag “#ZZZ” added thereto, are included in Tweet group previously obtained by a broadcasting station hashtag “#ZZZ.” In this case, it is determined that the hashtag “#A” and the hashtag “#B” are to be used as hashtags whereby the comments are to be acquired.

The search word determination unit 102 informs the search word store unit 103 of the determined hashtags (“#A” and “#B”) and instructs the search word store unit 103 to add the hashtags as hashtags the comments having which are to be acquired.

(Comment Acquisition Process S203)

To acquire Tweet, the comment acquisition unit 104 receives the start time and end time of the program from the program information acquisition unit 101 and acquires, from the search word store unit 103, the hashtags (“#A” and “#B”) included in Tweet to be acquired. The acquisition method is to acquire only Tweet that includes a specific hashtag, using a search function provided by Twitter (registered trademark).

The comment acquisition unit 104 acquires comments not only during the broadcast time of a program to which comments are posted are to be acquired, but also before and after the broadcast time. For example, when the broadcast time of the program to which comments are posted are to be acquired, is at midday to 13:00, the comment acquisition unit 104 acquires comments that are posted between 11:30 to 13:30 including 30 minutes before and after the broadcast time. The result is shown in FIG. 4.

FIG. 4 is a venn diagram showing another example of the set of hashtags for acquired comments. As shown in FIG. 4, the Tweet group which includes “#A” and the Tweet group which includes “#B” are obtained as a result of acquiring Tweet each includes only either “#A” or “#B”.

The comment acquisition unit 104 passes the acquired Tweet to the comment store unit 105, and the acquired Tweet is stored in the DB.

(Search Word Correctness Determination Process S204)

The comment time-distribution generating unit 106 acquires the acquired Tweet from the comment store unit 105, and generates a comment time distribution, based on a time at which each Tweet is posted. The comment time distribution is generated for each hashtag included in the comments to be acquired.

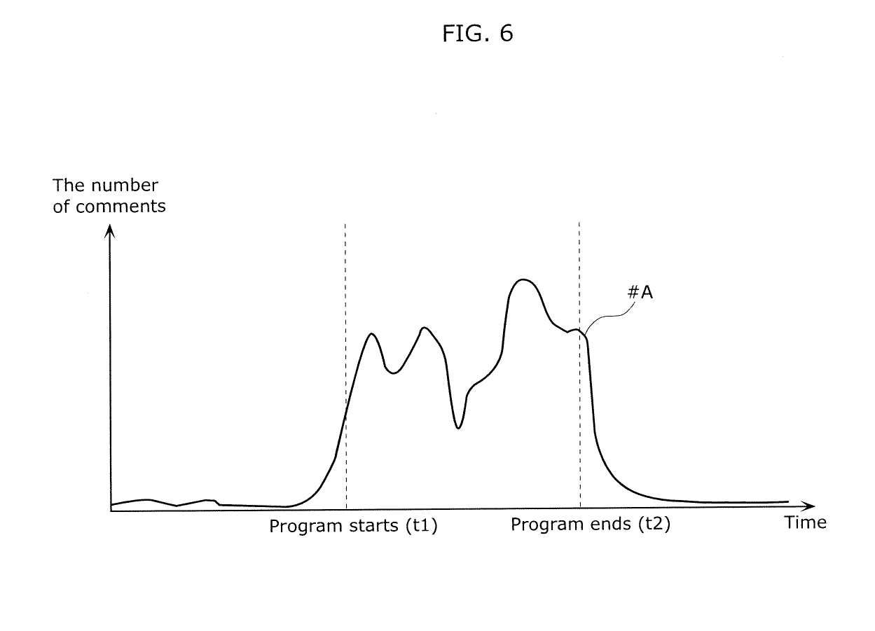

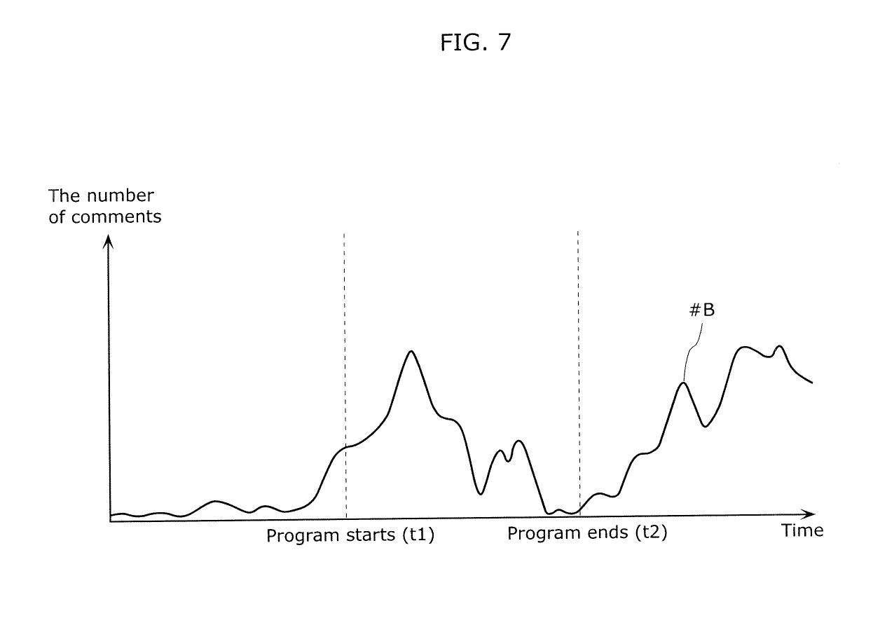

FIG. 6 is a chart showing an example of the comment time distribution of Tweet acquired by the hashtag “#A”. FIG. 7 is a diagram showing an example of the comment time distribution of Tweet acquired by the hashtag “#B”. The comment time-distribution generating unit 106 informs the generated comment time distribution to the search word relation determination unit 107.

The search word relation determination unit 107 determines whether the hashtag used for Tweet acquisition is unique to the program, based on the start time and end time of the program acquired from the program information acquisition unit 101 and the comment time distribution received from the comment time-distribution generating unit 106. The determination method is to check if the comment time distribution satisfies the following tendency.

(1) The number of Tweet starts increasing before the program start time.

(2) There is more than a predetermined number of Tweet during the program broadcast time.

(3) The number of Tweet decreases after the program end time.

When the above tendencies (1) to (3) are satisfied as indicated in the time distribution chart shown in FIG. 6, the hashtag “#A” used for the comment acquisition is determined to be the hashtag unique to the program. Meanwhile, when the above tendencies (1) to (3) are not satisfied as indicated in the time distribution chart shown in FIG. 7, the hashtag “#B” is determined not to be unique to the program.

Another determination method is to determine the hashtag unique to the program, based on the similarity in comment time distribution of a plurality of hashtags.

Specifically, when there is a plurality of hashtags unique to one program, and if the number of comments which include each of the hashtags indicates similar distribution tendency, it is determined that each hashtag is a hashtag unique to the program. The above determination method is possible because the number of comments which include each hashtag increases or decreases in accordance with the course of the program, and the number of comments which include each hashtag indicate distribution tendencies similar to each other. Specific example will be described below.

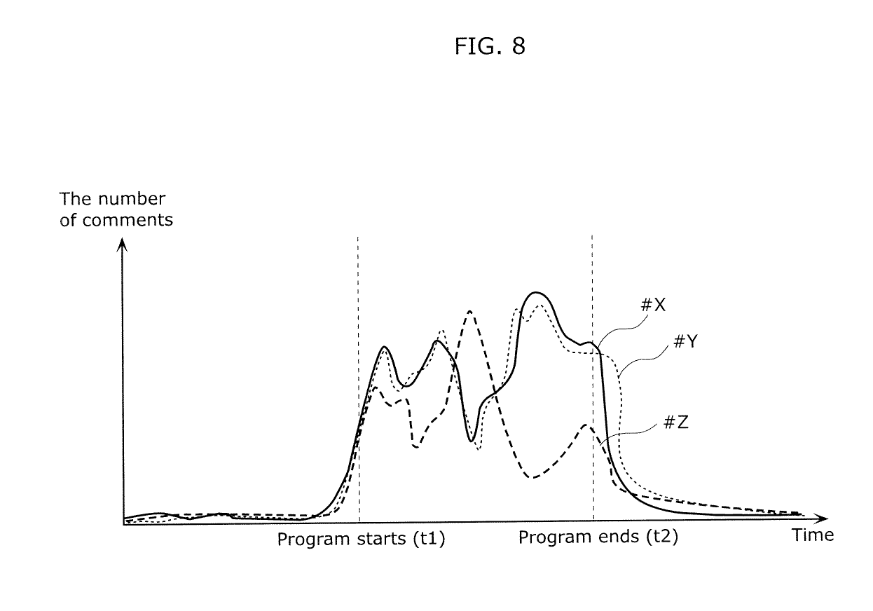

FIG. 8 shows another example of the time distribution chart of the acquired comments. FIG. 8 shows Tweet acquired by three or more hashtags (“#X”, “#Y”, and “#Z”). If the comment time distributions of the Tweet group acquired by the hashtags indicate similar distribution tendencies, the hashtags are determined to be the hashtags unique to the program. In the case of the hashtags (“#X”, “#Y”, and “#Z”) shown in FIG. 8, the hashtags (“#X” and “#Y”) are determined to be the hashtags unique to the program and the hashtag (“#Z”) indicating a different distribution tendency from the hashtags (“#X” and “#Y”) is determined not to be the hashtag unique to the program.

It should be noted that even when the number of comments having the hashtag “#Y” and a constant multiple of the number of comments having the hashtag “#X” have similar distribution tendencies, each hashtag is determined, similarly to the above, to be the hashtag unique to the program. This is because when the number of users using the hashtag “#X” is C times as the number of users using the hashtag “#Y”, the number of comments which include the hashtag “#X” is C times as the number of comments which include the hashtag “#Y”.

It should be noted that in determining the hashtag unique to the program, based on the comment time distribution, hashtags such as the broadcasting station hashtag that are apparently not unique to the program may be excluded from the hashtags to be determined.

(Search Word Deletion Process S205)

The search word relation determination unit 107 informs the search word store unit 103 of the hashtag (“#B”) determined not to be unique to the program, and instructs the search word store unit 103 to exclude the hashtag (“#B”) from the hashtags included in the comment to be acquired.

(Search Result Information Output Process S206)

The input/output unit 108 outputs information indicating a comment which includes the hashtag determined to be the hashtag unique to the program. Here, the information indicating the comment which includes the hashtag determined to be the hashtag unique to the program may be an identifier (ID) uniquely indicating the comment, a combination of the identifier (ID) uniquely indicating the comment and the search word, or the comment itself.

(3. Summary)

According to the information processing device 1 of the present embodiment, whether the hashtag used for the Tweet acquisition is unique to the program can automatically be determined.

As described above, according to the information processing device 1 of one embodiment of the present disclosure, when given the program information, the information processing device 1 can estimate the search word (the first search word) related to the program, based on the program information and already posted comments, and output a comment obtained by searching using the estimated search word or information indicating the comment. Thus, the information processing device 1 can obtain information for correctly extracting comments posted to the program.

Moreover, it is determined whether the search word (the first search word) related to the program is a search word which is actually used by users. This is because a large number of comments, in which the search word related to the program is described, are posted during the program broadcast time.

Moreover, it is determined whether the search word (the first search word) related to the program is the search word which is actually used by users. This is because the users start posting comments to the program before the program start time, continuously post comments during the program broadcast time, and end posting comments after the end of the program.

Moreover, it is determined, during the program time, whether the search word (the first search word) related to the program is the search word which is actually used by users. This is because the users start posting comments to the program before the program start time and continuously post comments during the broadcast time.

Moreover, it is determined whether the search word (the first search word) related to the program is the search word which is actually used by users. Because, when there is a plurality of search words for the same program, the plurality of search words has the same change pattern before the program broadcast time, after the program broadcast time, and during the program broadcast time. More specifically, when two search words A and B are present for the same program and the number of users using the search word A is C times as the number of users using the search word B, the number of comments having the search word A is C times the number of comments having the search word B.

Moreover, the search word (the first search word) related to the program can be extracted from the comments actually posted by users, and thus the search word is likely being related to the program. Thus, the information processing device 1 can correctly extract the comment posted to the program, in an efficient manner.

Moreover, the information processing device 1 can estimate, in advance, the search word related to a previously broadcasted program, store therein information indicating a search result obtained using the search word, and output the information indicating the search result obtained using the search word, as a response to an inquiry from a user.

Moreover, the information processing device 1 can output, during the program broadcast time, the information indicating the search result obtained using the search word, as a response to an inquiry from a user.

### Embodiment 2

In the present embodiment, an information processing device will be described which estimates search words that are related to a program, including, as a candidate for the search word, another search word (a second search word) described in a comment that includes the search word (the first search word) estimated by the embodiment 1, and outputs a comment obtained by searching using the estimated search words or information indicating the comment.

(1. Configuration)

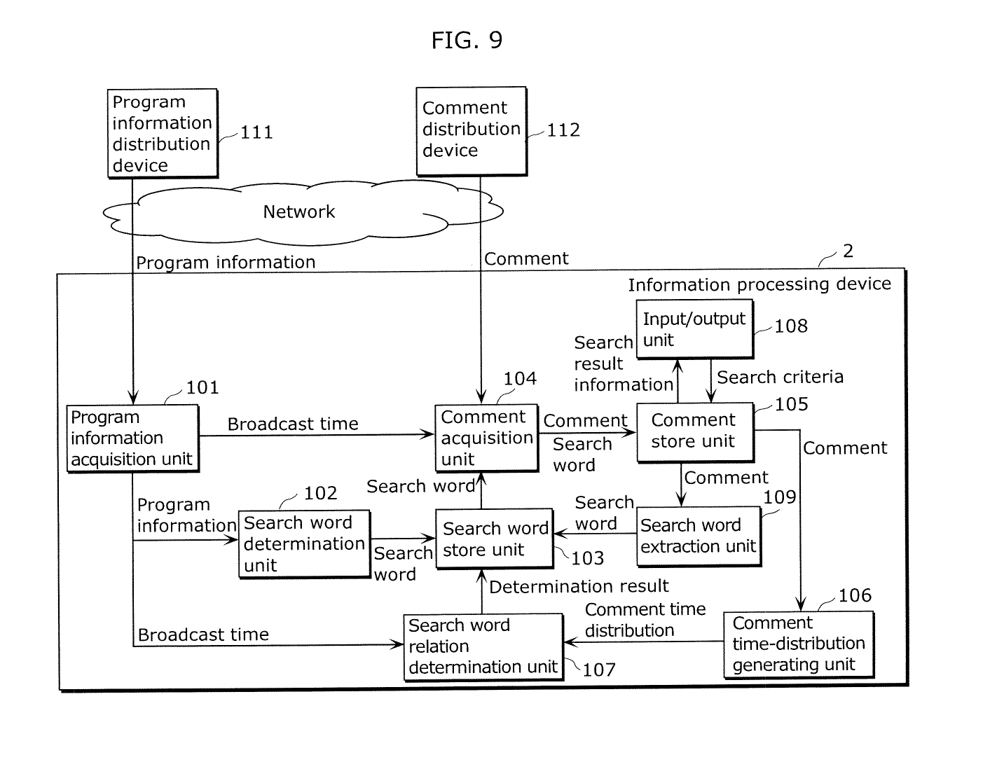

FIG. 9 is a functional block diagram of the information processing device 2 according to a non-limiting embodiment 2.

(Overall Configuration)

As shown in FIG. 9, the information processing device 2 according to the present embodiment includes a program information acquisition unit 101, a search word determination unit 102, a search word store unit 103, a comment acquisition unit 104, a comment store unit 105, a comment time-distribution generating unit 106, a search word relation determination unit 107, an input/output unit 108, and a search word extraction unit 109.

The program information acquisition unit 101, the search word determination unit 102, the search word store unit 103, the comment store unit 105, the comment time-distribution generating unit 106, the search word relation determination unit 107, and the input/output unit 108 are the same as those according to the embodiment 1, and thus the description thereof will be omitted below.

(Search Word Extraction Unit 109)

The search word extraction unit 109 parses an acquired comment to extract a search word to be newly used for comment acquisition. The search word extraction unit 109 receives the comment from the comment store unit 105 and passes the extracted search word to the search word determination unit 103.

(Comment Acquisition Unit 104)

Similarly to the embodiment 1, the comment acquisition unit 104 uses the search word stored in the search word store unit 103 to acquire a comment. In addition, the comment acquisition unit 104 uses the search word (the second search word) newly added by the search word extraction unit 109 to acquire a comment. The comment acquisition unit 104 also uses the newly added search word to determine whether comment reacquisition is to be performed or the comment acquisition is to be ended.

(2. Operation)

(Overall Operation)

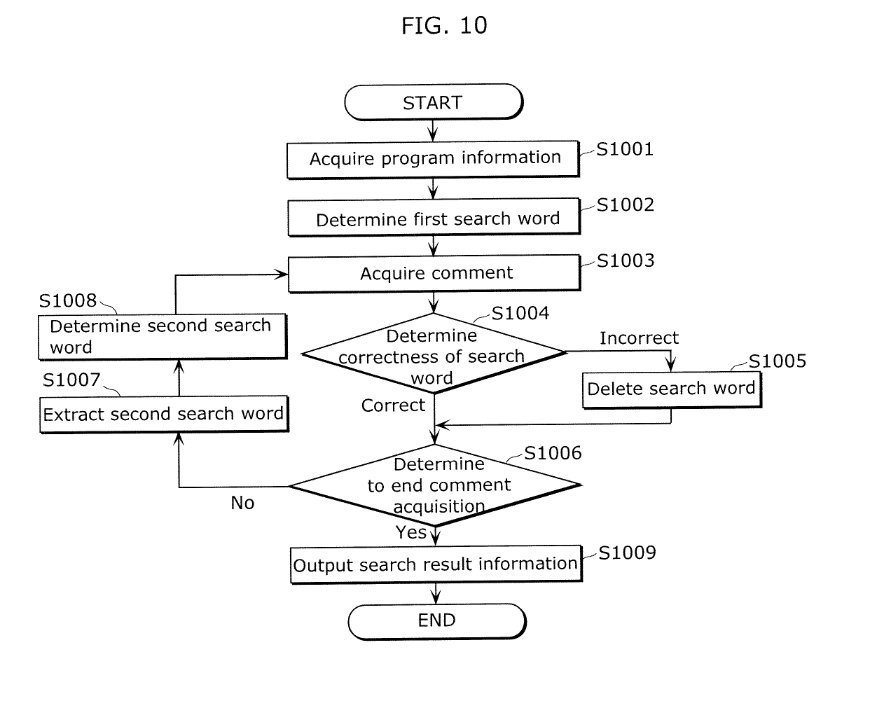

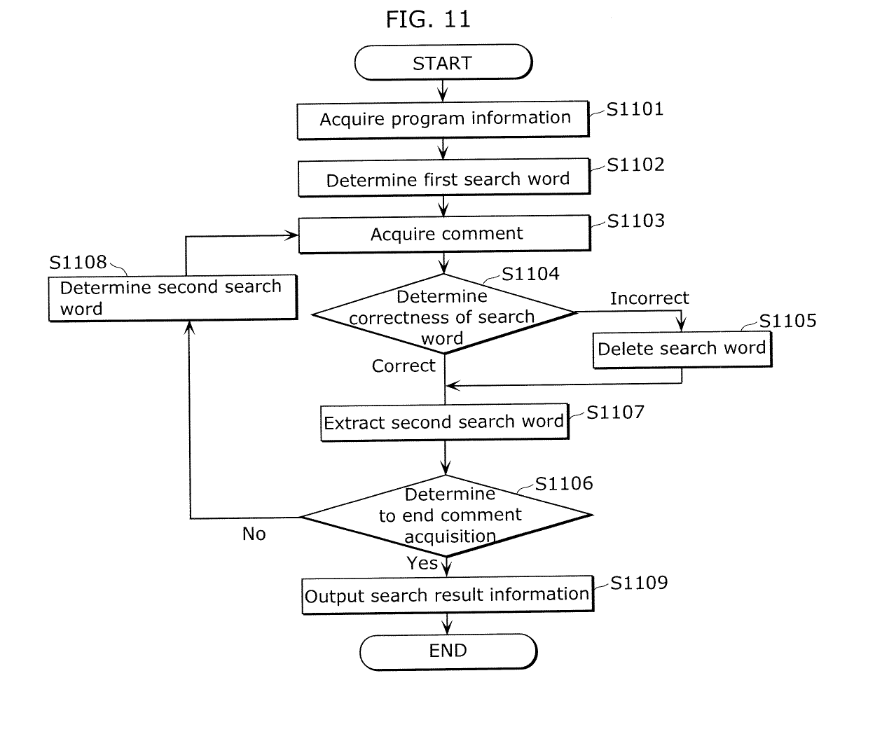

FIG. 10 and FIG. 11 each show a flowchart illustrating an example of operation of the information processing device according to the present embodiment. The flowcharts shown in FIG. 10 and FIG. 11 have different orders of performing a search word extraction process (S1007 and S1107) described below. In the flowchart of FIG. 10, the comment acquisition end determining process (S1006) described below is performed and then the search word extraction process (S1007) is performed. In the flowchart of FIG. 11, however, the search word extraction process (S1107) is performed and then the comment acquisition end determining process (S1106) is performed. In the below description, a case of acquiring the comment (Tweet) of Twitter (registered trademark) will be described, and the comment and the search word will be denoted as Tweet and hashtag, respectively.

A program information acquisition process (S1001 and S1101), a first search word determination process (S1002 and S1102), a search word correctness determination process (S1004 and S1104), a search word deletion process S1005 and S1105, and a search result information output process S1009 and S1109 are the same as those in the embodiment 1 and thus the description thereof will be omitted below.

(Comment Acquisition End Determining Process S1006 and S1106)

The comment acquisition unit 104 determines whether the Tweet acquisition process is to be continued or ended. Examples of the determination method include the following.

(1) Repeat Tweet acquisition for a predetermined number of times.

(2) End Tweet acquisition when a total number of hashtags determined to be positive by the search word correctness determination process (S1004 and S1104) is above a predetermined number.

(3) End Tweet acquisition when a total number of acquired Tweet is above a predetermined number.

(4) Ends Tweet acquisition when the number of Tweet immediately previously acquired is less than a predetermined number.

(5) As in the flowchart illustrated in FIG. 11, when the search word extraction process (S1107) described below is performed prior to performing the comment acquisition end determining process (S1106), there is a method to end the Tweet acquisition when the frequency of the hashtag extracted by the search word extraction process (S1107) in

Tweet is less than a predetermined number.

(Search Word Extraction Process S1007 and S1107)

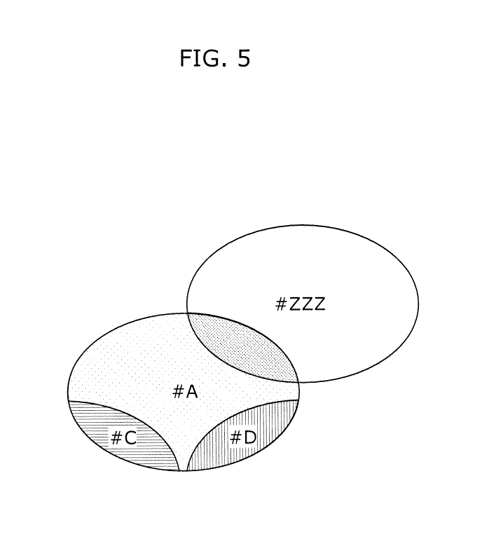

The search word extraction unit 109 parses the acquired Tweet to extract a hashtag that can be newly used for Tweet acquisition. Using the venn diagram of FIG. 5 as an example, when the Tweet group obtained using the hashtag “#A” determined, at the previous Tweet acquisition, to be unique to the program includes hashtags “#C” and “#D” previously unused for Tweet acquisition, “#C” and “#D” are candidates for hashtags to be newly used for Tweet acquisition.

(Search Word Determination Process S1008 and S1108)

The search word extraction unit 109 determines whether a hashtag extracted by the search word extraction process (S1007 and S1107) is to be used for the Tweet acquisition, and if it is determined that the hashtag is to be used for the Tweet acquisition, the search word extraction unit 109 notifies the search word store unit 103 and the hashtag is registered.

One method of determining whether the hashtag is to be used for the Tweet acquisition is to check how frequent the extracted hashtag occurs in Tweet. If the frequency is less than a predetermined value, it is determined that the hashtag is not to be used for search. Tweet can be added with a plurality of hashtags, and a hashtag unrelated to the program may be included in the plurality of hashtags. Thus, by checking the frequency, the hashtag unrelated to the program can be eliminated.

In the case where a plurality of hashtags are extracted, for example, the frequency of each of the extracted hashtags is checked and every hashtag the frequency of which is above the predetermined value may be registered in the search word store unit 103, or the number of hashtags registered at a time may be restricted such as top three hashtags.

(Comment Acquisition S1003 and S1103)

The comment acquisition unit 104 uses the newly added hashtag to retroactively acquire Tweet posted during the program broadcast time.

(Loop Process S1003, S1103 to S1008, and S1108)

Until the comment acquisition end determining processes S1006 and S1106 determine that an end condition for the Tweet acquisition is satisfied, Tweet related to the program is continuously acquired by repeating the Tweet acquisition, the hashtag correctness determination, and the extraction of the search word, thereby enhancing the accuracy in acquiring the Tweet.

(3. Summary)

According to the information processing device 2 of the present embodiment, a hashtag is extracted from the acquired Tweet, and, using the hashtag, Tweet is reacquired, thereby enhancing the accuracy in acquiring a program-related Tweet.

As described above, according to the information processing device 2 of one embodiment of the present disclosure, the second search word suitable for identifying the program can be estimated in the comments obtained by searching using the first search word, and the comment obtained by searching using the estimated second search word or information indicating the comment can be outputted. Thus, the information processing device 2 can correctly extract comments that are posted to the program, at high accuracy.

Moreover, the information processing device 2 estimates a new search word described in the comments obtained by searching using the estimated search word. Thus, the information processing device 2 can correctly extract comments that are posted to the program, at an increased accuracy.

As described above, while the method of implementing the present disclosure is described based on the embodiments, the present disclosure is not limited to the embodiments. Various modifications to the present embodiments that may be conceived by those skilled in the art and other embodiments constructed by combining constituent elements in different embodiments are included in the scope of the present disclosure, without departing from the essence of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

According to the present disclosure, in acquiring an SNS comment related to a program, determination can automatically be made as to whether a search word used for the acquisition of the SNS comment is unique to the program. Thus, an information processing device which automatically determines and provides the search word unique to the program can be achieved, thereby efficiently acquiring the SNS comment related to the program.

1. An information processing device for outputting information on a comment having additional information and posted in relation to a program to an external server, the information processing device comprising:
a program information acquisition unit configured to acquire program information which includes information indicating a broadcast time during which the program is broadcasted;
a search word determination unit configured to determine a first search word which is a candidate for a term described in the additional information to indicate a relation to the program;
a comment acquisition unit configured to search through comments each having the additional information and already posted, using, as a search key, the first search word determined by the search word determination unit, to acquire a search result as a first comment group;
a search word relation determination unit configured to determine whether there is a relation between the first search word and the program, using the broadcast time and a time at which each of the comments included in the first comment group acquired by the comment acquisition unit is posted; and
an output unit configured to output information indicating the search result when the search word relation determination unit determines that there is the relation between the first search word and the program.

2. The information processing device according to claim 1,
wherein for the number of comment posts per unit time of the comments included in the first comment group, when the number of posts during the broadcast time of the program is greater than the number of posts off the broadcast time of the program, the search word relation determination unit is configured to determine that there is the relation between the first search word and the program.

3. The information processing device according to claim 1,
wherein for the number of comment posts per unit time of the comments included in the first comment group, when the number of posts increases before a start time of the program, the number of posts during the broadcast time of the program is greater than or equal to a predetermine value, and the number of posts decreases after an end time of the program, the search word relation determination unit is configured to determine that there is the relation between the first search word and the program.

4. The information processing device according to claim 1,
wherein when the number of comment posts per unit time of the comments included in the first comment group increases before a start time of the program and is greater than or equal to a predetermined value during the broadcast time of the program, the search word relation determination unit is configured to determine that there is the relation between the first search word and the program.

5. The information processing device according to claim 1,
wherein when patterns of change in the number of comment posts per unit time of the comments included in the first comment group corresponding to two of a plurality of the first search words are similar to each other, the search word relation determination unit is configured to determine that there is the relation between the program and each of the two of the plurality of first search words.

6. The information processing device according to claim 1,
wherein when a sum of differences between the number of comment posts per unit time of the comments included in the first comment group corresponding to one of two of a plurality of the first search words and a constant multiple of the number of comment posts per unit time of the comments included in the first comment group corresponding to the other of the two of the plurality of first search words in a predetermined time period is smaller than a predetermined value, the search word relation determination unit is configured to determine that there is the relation between the program and each of the two of the plurality of first search words.

7. The information processing device according to claim 1,
wherein the search word determination unit is configured to determine as the first search word a character string extracted from a description in each of the comments having the additional information and already posted.

8. The information processing device according to claim 1 further comprising
a search word extraction unit configured to extract a second search word different from the first search word from a description in each of the comments included in the first comment group,
wherein the comment acquisition unit is configured to search through the comments each having the additional information and already posted, using the second search word as the search key, and acquire a search result as a second comment group,
the search word relation determination unit is configured to determine whether there is an relation between the second search word and the program, using the broadcast time and a time at which each of the comments included in the second comment group is posted, and
when the search word relation determination unit determines that there is the relation between the second search word and the program, the output unit is configured to output information indicating the search result obtained by searching through the comments using the second search word as the search key.

9. The information processing device according to claim 8,
wherein using the second search word as a new first search word, the information processing device recursively and iteratively performs a series of processing steps including acquiring the first comment group by the comment acquisition unit, determining the relation between the new first search word and the program by the search word relation determination unit, and outputting the search result by the output unit, and when a predetermined condition is met, the information processing device ends the series of processing steps.

10. The information processing device according to claim 9,
wherein the information processing device ends the series of processing steps after performing the series of processing steps for a predetermined number of times.

11. The information processing device according to claim 9,
wherein the information processing device ends the series of processing steps when a total number of pieces of information indicating the search result obtained by searching through the comments using the second search word outputted in each of the series of processing steps is greater than a predetermined value.

12. The information processing device according to claim 9,
wherein the information processing device ends the series of processing steps when a total number of comments included in the first comment group and the second comment group in the series of processing steps is greater than a predetermined value.

13. The information processing device according to claim 9,
wherein the information processing device ends the series of processing steps when a total number of comments included in the second comment group in the series of processing steps is smaller than a predetermined value.

14. The information processing device according to claim 9,
wherein the information processing device ends the series of processing steps when a ratio of the number of comments which include the second search word extracted from each of the comments included in the first comment group to the number of comments included in the first comment group in the series of processing steps is smaller than a predetermined value.

15. The information processing device according to claim 1,
wherein the program information includes information indicating the broadcast time during which the program is broadcasted and information indicating a broadcasting station which broadcasts the program.

16. The information processing device according to claim 8 further comprising
an input unit configured to receive, as input, information whereby the program for which broadcasting has already been finished is identified,
wherein the output unit is configured to output information indicating the search result obtained by searching through the comments using at least one of the first search word and the second search word determined, by the search word relation determination unit, to be related to the program.

17. The information processing device according to claim 8 further comprising
an input unit configured to receive, as input, information whereby the program being broadcasted is identified,
wherein the output unit is configured to output information indicating the search result obtained by searching through the comments using at least one of the first search word and the second search word determined, by the search word relation determination unit, to be related to the program.

18. The information processing device according to claim 1,
wherein when the search word relation determination unit determines that there is the relation between the first search word and the program, the output unit is configured to output, as the information indicating the search result, the first comment group or the first search word and a range which specifies the comments included in the first comment group.

19. An information processing method for outputting information on a comment having additional information and posted in relation to a program to an external server, the information processing method comprising:
acquiring program information which includes information indicating a broadcast time during which the program is broadcasted;
determining a first search word which is a candidate for a term described in the additional information to indicate a relation to the program;
searching through comments each having the additional information and already posted, using, as a search key, the first search word determined in the first search word determination to acquire a search result as a first comment group;
determining whether there is a relation between the first search word and the program, using the broadcast time and a time at which each of the comments included in the first comment group acquired in the first comment group acquisition is posted; and
outputting information indicating the search result when it is determined that there is the relation between the first search word and the program in the relation determination.

20. A program which is recorded in a non-transitory computer readable recording medium and for causing a computer to execute the information processing method according to claim 19.
